(19) United States
(12) Patent Application Publication
(10) Pub. No.: US 2021/0141801 A1
(43) Pub. Date: May 13, 2021

(54) String Parsed Categoric Encodings for Machine Learning

(71) Applicant: Nicholas John Teague, Altamonte Springs, FL (US)

(72) Inventor: Nicholas John Teague, Altamonte Springs, FL (US)

(21) Appl. No.: 17/021,770

(22) Filed: Sep. 15, 2020

Related U.S. Application Data
(60) Provisional application No. 62/932,895, filed on Nov. 8, 2019.

(51) Int. Cl. G06F 16/25; G06N 20/00; G06F 16/22; G06F 40/253

(52) U.S. Cl. CPC G06F 16/258; G06F 40/253; G06F 16/221; G06N 20/00

(57) ABSTRACT

A technique for automated preparation of tabular data categoric feature set encodings for machine learning, including options for variations on categoric encodings for bounded and unbounded categoric sets. String parsing may be performed to extract grammatical structure shared between the entries in a categoric feature set, such as string character subset overlaps, which may be returned in one or more columns of overlap activations or may be used to consolidate entries with shared overlaps. Numeric substring partitions may be extracted. Search terms may be applied to identify entries containing specific substring partitions. Sets of transformations may be aggregated by use of transformation primitives such as to return encodings in multiple configurations of varying information content. Additional data sets may be consistently prepared to training data sets based on properties of training data saved in a returned metadata database such as for use in inference from a trained machine learning system.

### BACKGROUND

Machine learning (ML) is becoming an increasingly important part of the software landscape. Machine learning is a type of artificial intelligence (AI) and ML helps enable a software system to learn to recognize patterns from data without being directly programmed to do so. Machine learning can refer to a wide range of techniques. Examples of ML techniques can include random forests, gradient boosting machines, neural networks, etc. ML techniques may be based on supervised or unsupervised learning techniques. Broadly, ML operates in two phases, a training phase, whereby models and/or weights are adjusted based on input training data, and an inference phase whereby these models and/or weights are applied to actual input data to generate predictions. In supervised learning the training phase makes use of training data and labels, in unsupervised learning the training is performed without labels based on algorithmically inferred properties, such as groupings or correlations, within the training data.

Generally, supervised ML operates by defining one or more levels of statistical relationships, often referred to as weights, between various features of input data. These weights are generally defined and/or adjusted in a training phase. During the training phase, labeled training data is fed into a ML system. The ML system effectively takes a best guess based on the weights in the ML system applied to the training data and outputs a result. This result is compared to the labels of the training data. These labels define the ground truth which the ML system is being trained to detect. Results of the comparison between the labels and the output of the ML system are used to iteratively update the weights of the ML system. Typically, a ML system may be trained on a substantial amount of training data, typically on the order of hundreds to millions of sample inputs or more. Often the quality and amount of training data can directly influence the quality of the resulting ML system.

Data for a ML system often needs to be manipulated or numerically encoded prior to being used for training. Further, to reliably generate predictions using the ML system after training, test data that is consistent with the training data should be used. Consistency of the test data may be provided by manipulating or numerically encoding the test data in a manner consistent with the training data. For example, data may need to be transformed into tidy tabular data, have feature engineering applied, normalized, converted to a useable encoding, missing data infilled, dimensionally adjusted, separated into various data sets for training and validation, shuffled to randomize the order of samples while maintaining row correspondence between associated sets, etc. Specific transformations and/or parameters of those transformations may be derived based on properties of the data in the training set to avoid potential data leakage as between the training data, validation data, and test data. Often one or more of these transformation steps require manual operations, for example, by a data analyst or programmer. After initial training is complete, there may be a desire for additional consistent data processing, for example, to generate predictions by the ML system, to fine tune or adjust the ML system to better handle cases in which were not properly handled by the ML system after the initial training, or to train a new ML model with consistently formatted data.

In a tidy tabular data set, for example where feature sets are aggregated by distinct columns and observations are aggregated by distinct rows, a fundamental category of feature set type that may be present in a column is categoric data, in which each sample category has a unique value representation in the set of entries such as may be populated as a string or number. Mainstream ML systems may rely on these categoric feature sets being prepared in a numerical encoding and/or with all valid entries. Examples of mainstream methods to numerically encode categoric feature sets may include one-hot encoding, in which a categoric feature set is returned as a set of columns with a distinct column for activations associated with each categoric unique value, ordinal encoding in which a categoric feature set is returned as a single column with a distinct integer encoding associated with each categoric unique value, etc. Each of these mainstream methods share in common that the grammatical structure of the categoric entries are discarded for representation by numbers. As a result, the ML training operation may not be exposed to any insights that could be inferred by grammatical structure shared between entries in a categoric feature set. Thus, what is needed is a technique for automatically encoding categoric feature sets in a manner that includes extractions of grammatical structure shared between entries in the categoric feature set used in training of a ML system, which encodings may then serve as a basis for consistent form of encoding to additional data set feature sets such as may be applied for inference from the trained ML system.

### SUMMARY

This disclosure relates generally to machine learning (ML). More particularly, but not by way of limitation, aspects of the present disclosure relate to a method for encoding categoric feature sets with extracted grammatical structure shared between entries to help consistently prepare data for a ML system based on properties of transformations that may be derived from a training set categoric feature set based on a received tabular training data set with one or more categoric feature sets. In certain cases, the data sets may be in a tidy data form where tidy data refers to having a single column per feature and a single row per observation. The method includes identifying or assigning column labels from the training data set, the column labels associated with a source column of data points, and determining, for each identified column label, a root category based on at least one of a user assignment, one or more variable types, data properties, or distribution properties associated with the data points in each column of the set of source columns, performing one or more data transformations for data points in one or more of the source columns, the data transformations including techniques for extracting and encoding a grammatical structure that may be shared between entries of a categoric feature set, recording the column categories determined for each identified column label and properties of the data transformations performed for each source column in a metadata database, outputting the metadata database and transformed training data set for training a ML system, receiving a tabular additional data set and the metadata database, performing the one or more data transformations for data points in corresponding additional columns of the tabular additional data set using the recorded column categories and properties of the data transformations from the metadata database to obtain a transformed additional data set, and outputting the transformed additional data set for use with the ML system.

Another aspect of the present disclosure relates to a non-transitory program storage device comprising instructions stored thereon to cause one or more processors to receive a tabular training data set, the tabular training data set including a set of source columns having one or more source columns with categoric feature sets. In certain cases, the data sets may be in a tidy data form where tidy data refers to having a single column per feature and a single row per observation. The instructions further cause the one or more processors to identify or assign column labels from the training data set, the column labels associated with a source column of data points, and determine, for each identified column label, a root category based on at least one of a user assignment, one or more variable types, data properties, or distribution properties associated with the data points in each column of the set of source columns, perform one or more data transformations for data points in one or more of the source columns, the data transformations including techniques for extracting and encoding a grammatical structure that may be shared between entries of a categoric feature set, record the column categories determined for each identified column label and properties of the data transformations performed for each source column in a metadata database, output the metadata database and transformed training data set for training a ML system, receive a tabular additional data set and the metadata database, perform the one or more data transformations for data points in corresponding additional columns of the tabular additional data set using the recorded column categories and properties of the data transformations from the metadata database to obtain a transformed additional data set, and output the transformed additional data set for use with the ML system.

Another aspect of the present disclosure relates to an electronic device, comprising a memory, and one or more processors operatively coupled to the memory, wherein the one or more processors may be configured to execute instructions causing the one or more processors to receive a tabular training data set, including a set of source columns having one or more source columns with categoric feature sets. In certain cases, the data sets may be in a tidy data form where tidy data refers to having a single column per feature and a single row per observation. The instructions further cause the one or more processors to identify or assign column labels from the training data set, the column labels associated with a source column of data points, and determine, for each identified column label, a root category based on at least one of a user assignment, one or more variable types, data properties, or distribution properties associated with the data points in each column of the set of source columns, perform one or more data transformations for data points in one or more of the source columns, the data transformations including techniques for extracting and encoding a grammatical structure that may be shared between entries of a categoric feature set, record the column categories determined for each identified column label and properties of the data transformations performed for each source column in a metadata database, output the metadata database and transformed training data set for training a ML system, receive a tabular additional data set and the metadata database, perform the one or more data transformations for data points in corresponding additional columns of the tabular additional data set using the recorded column categories and properties of the data transformations from the metadata database to obtain a transformed additional data set, and output the transformed additional data set for use with the ML system.

Another aspect of the present disclosure relates to a system comprising a memory, and one or more processors operatively coupled to the memory, wherein the one or more processors may be configured to execute instructions causing the one or more processors to receive a tabular training data set, including a set of source columns having one or more source columns with categoric feature sets. In certain cases, the data sets may be in a tidy data form where tidy data refers to having a single column per feature and a single row per observation. The instructions further cause the one or more processors to identify or assign column labels from the training data set, the column labels associated with a source column of data points, and determine, for each identified column label, a root category based on at least one of a user assignment, one or more variable types, data properties, or distribution properties associated with the data points in each column of the set of source columns, perform one or more data transformations for data points in one or more of the source columns, the data transformations including techniques for extracting and encoding a grammatical structure shared between entries of a categoric feature set, record the column categories determined for each identified column label and properties of the data transformations performed for each source column in a metadata database, output the metadata database and transformed training data set for training a ML system, receive a tabular additional data set and the metadata database, perform the one or more data transformations for data points in corresponding additional columns of the tabular additional data set using the recorded column categories and properties of the data transformations from the metadata database to obtain a transformed additional data set, and output the transformed additional data set for use with the ML system.

The data transformations may be useful for meeting prerequisites of machine learning algorithms such as numerical encoding, applying infill to missing values, and/or for improving the accuracy or efficiency of ML training such as by improved information retention of encodings, normalization, or feature engineering.

Additionally, another aspect of one or more portions of the present disclosure relates to the extraction of grammatical structure shared between entries in a categoric feature set in the training and/or test data sets. More particularly, but not by way of limitation, aspects of the present disclosure relate to, for entries in a categoric feature set, comparing string character subsets of an entry to string character subsets of other entries in the set, identifying cases where overlaps in string character subsets are present, and populating one or more columns with activations associated with identified overlaps corresponding to the associated entries in the categoric feature set.

Additionally, another aspect of one or more portions of the present disclosure relates to the use of extractions of grammatical structure shared between entries in a categoric feature set to consolidate the entries to a reduced number of unique values. More particularly, but not by way of limitation, aspects of the present disclosure relate to, for entries in a categoric feature set, comparing string character subsets of an entry to string character subsets of other entries in the set, identifying cases where overlaps in string character subsets are present, and consolidating entries in the categoric feature set sharing those overlaps to common representations for a reduced number of unique values.

Additionally, another aspect of one or more portions of the present disclosure relates to the extraction of numeric partitions of entries in a categoric feature set. More particularly, but not by way of limitation, aspects of the present disclosure relate to, for entries to a categoric feature set, inspecting string subset extracts, testing the string subset extracts for validity as a numeric character set, and returning a set of extracted numeric entries.

Additionally, another aspect of one or more portions of the present disclosure relates to the application of a search function to the entries of a categoric feature set. More particularly, but not by way of limitation, aspects of the present disclosure relate to, for entries to a categoric feature set, inspecting string subset extracts, testing the string subset extracts for correspondence to a set of search terms, and populating one or more columns with activations associated with identified search terms present as string character subsets in the associated entries to the categoric feature set.

Additionally, another aspect of one or more portions of the present disclosure relates to the aggregation of transformation functions to prepare entries of a categoric feature set with string parsed encodings. More particularly, but not by way of limitation, aspects of the present disclosure relate to, for a categoric feature set source column, performing one or more data transformations for data points in an order based on defined primitives of a transformation tree to obtain a transformed data set, the transformation tree including defined primitive category entries associated with each root category, wherein the defined primitives associated with the source column are based on a root category associated with the source column, and wherein the defined primitive category entries for the root category are associated with a set of data transformations, the set of data transformations including one or more types of data transformations to be performed, resulting in encoding the entries into a returned set that may include aggregations of categoric encodings, numerical extracts, search activations, string parsed encodings, and/or other types of data transformations, which in some cases may include generations and branches of derivations, for application of ML.

### BRIEF DESCRIPTION OF THE DRAWINGS

For a detailed description of various examples, reference will now be made to the accompanying drawings in which:

FIG. 1 is a block diagram of an application for preparing structured datasets for ML training, in accordance with aspects of the present disclosure.

FIG. 2 illustrates example outputs based on example sets of inputs to return categoric encodings, in accordance with aspects of the present disclosure.

FIG. 3 illustrates example outputs based on an example set of inputs to return string parsed encodings for bounded categoric sets, in accordance with aspects of the present disclosure.

FIG. 4 illustrates example outputs based on an example set of inputs to return string parsed encodings for unbounded categoric sets, in accordance with aspects of the present disclosure.

FIG. 5 is a graph diagram of transformation function application from a transformation tree aggregation of string parsed encodings for bounded categoric sets, in accordance with aspects of the present disclosure.

FIG. 6 illustrates example outputs based on an example set of inputs to return a transformation tree aggregation of string parsed encodings for bounded categoric sets, in accordance with aspects of the present disclosure.

FIGS. 7A and 7B illustrate an example of a transformation function specification for a transformation tree aggregation of string parsed encodings for bounded categoric sets, in accordance with aspects of the present disclosure.

FIG. 8 is a flow diagram for a technique for processing data in an initial ML data set transformation process and consistently processing additional data in an additional ML data set transformation process, in accordance with aspects of the present disclosure.

FIG. 9 is a block diagram of an embodiment of a computing device, in accordance with aspects of the present disclosure.

### DETAILED DESCRIPTION

FIG. 1 is a block diagram of an application for preparing structured datasets for ML training 100, in accordance with aspects of the present disclosure. Often, training data may be processed to prepare the data for use in training ML systems. For example, the training data may be received in a tidy form with each column representing a particular feature and a single row represents a particular observation. The data may be transformed to extract or enhance the information available in the data set, for example, through numerical encoding, normalization, boolean conversion, infill, etc. Additionally, one or more datasets may be separated into subsets. For example, labels may also be split out into a separate set associated with the other data sets, and the training set may be split between a training data set and one or more validation data sets. In certain cases, test data sets may be received separate from the training data set and transformed. In certain cases, the transformations applied to the test data sets may be substantially consistent with those applied to the training data set. After the initial data sets are prepared, the data sets may be used to train the target ML system. Post training, it may be desirable to be able to consistently prepare additional data sets for the target ML system. As used herein, consistent preparation, consistent processing, or consistent formatting refers to applying transformations in a substantially consistent manner to those applied to the training data set, or data sets that have been so transformed. This additional data sets may be used, for example, to generate predictions using the target ML system, perform additional training of the target ML system, or train a new ML model with consistently formatted data. As the initial training data set processing can involve a significant number of steps and application of specific data transformation processes, it would be desirable to have a system capable of streamlining the processing of the additional data that is consistent with how the initial training data set was processed.

Referring to the current example, an initial training data set 102 may be received by a ML data set transformation process 106. In certain cases, the initial training data set 102 may be received along with an initial test data set 104. The ML data set transformation process 106 performs a series of transformation steps on the received data sets and outputs the processed training data set 108. In some cases, a consistently processed validation data set 110 may also be output. In some cases, a processed test data set 112 may also be output if a test data set 104 was received and/or requested. In cases where the test data set 104 is not provided, the processed test data set 112 may be based on portions of the processed training data set 108. The processed training data set 108 and, in some cases, processed validation data set 110 may be used by the target ML system 118 for training the ML system 118. In cases where the test data set 104 was passed to the initial ML data set transformation process 106, the returned processed test data set 112 may be used by the target ML system 118, for example, for making predictions based on the test data set 104. In some cases, the training and/or prediction generation of the target ML system 118 using processed data sets may be supplemented by an external corresponding data sets not processed by the initial ML data set transformation process 106 and/or the processed test data set 112, for example such as if labels are not passed, or, as another example, if a row may have a corresponding image file. In such cases, the pairing of processed data sets with external corresponding data sets may be supported by an ID set containing row index information which may be returned as a separate information type for the returned processed data sets. The target ML system 118 may be any ML system and in some cases may be separate from the ML data set transformation process 106.

The series of transformation steps performed by the ML data set transformation process 106 may be user defined, or in certain cases, automatically determined by the ML data set transformation process 106 based on properties of the data in the received training data set 102. The ML data set transformation process 106 tracks the specific transformations applied to the data sets and outputs parameters of these transformations in a separate metadata database 114. Additionally, a feature importance results report 116 may also be outputted. In certain cases, the feature importance results report 116 may be an informational report, for example to the user. In certain cases, results of a feature importance evaluation may also be included in the metadata database 114. The metadata database 114 may be provided to the ML data set transformation process 122 to process an additional test data set 120. Consistent processing of this additional test data set 120 may be performed based on information from the metadata database 114 without having to specify the specific transformations. Where the ML data set transformation process 106 determined specific transformation processes to apply to the initial training data set 102, these specific transformation processes may be applied based on the metadata database 114 without redetermining those specific transformation processes and/or redetermining transformation parameters inferred from properties of the training data. An additional test data set 120 may thus be processed by an additional ML data set transformation process 122 and the returned processed additional test set 124 may be used by the target ML system 118, for example, for making predictions based on the additional test data set 120.

In certain cases, if the scale of data in an original training data 102 set exceeds a resource limit, such as a memory limit, run time limit, user defined time constraint, etc., there may be a desire to partition the original training data set into an initial training set and one or more additional training data sets. Information in the initial training data set may be used to generate and populate a metadata database 114 indicating the transformations applied to obtain the processed training data set 108. Consistent transformations may then be applied to the remaining partition or partitions of the original training data set by passing this data to the additional ML data set transformation process 122 as an additional test data set 120 in conjunction with the returned metadata database 114 to process the remainder of the original training data set to be returned as a processed additional test data set 124. Similarly, when the scale of data in a test data set 104 or additional test data set 120 exceeds the resource limit, that data set may be partitioned for iterated application of consistent processing in the additional ML data set transformation process 122. In some cases, the application of consistent processing in the additional ML data set transformation process 122 may be parallelized across data set partitions.

Referring to the process flow for FIG. 1, an alternate means for consistent processing of the additional test data set at block 120 may be achieved without the use of the metadata database of block 114 and without the use of the additional ML data set transformation process of block 122 by passing the additional test data set of block 120 to the initial ML data set transformation process of block 106 as a test data set of block 104 in conjunction with the original training data set for which consistent processing is desired as block 102, returning a processed test data set 112 comparable to the processed additional test data set of block 124.

FIG. 2 illustrates example outputs based on example sets of inputs to return categoric encodings 200, in accordance with aspects of the present disclosure. In a tabular data set, such as a tidy set in which feature sets are aggregated by distinct columns and samples are aggregated by distinct rows, categoric data may be a category of feature set type that may be present in a column. Categoric feature sets may include entries of disparate data types, such as strings and/or numbers, and the set of observations may include one or more occurrences of each unique value. Categoric feature sets may have a bounded range of entries, in which case the range of unique values found in a training set feature set may correspond to the range of unique values found in a corresponding test set feature set, or may have an unbounded range of entries, in which case the range of unique values found in a training set feature set may not be the same as the range of unique values found in a corresponding test set feature set. In some cases, in unbounded categoric feature sets, both training and test set feature sets may contain all-unique entries, where there is no overlap between the range of unique values in a training set feature set and the range of unique values found in corresponding test set feature sets. Here, training set may refer to the data set used to train a target ML system and test data set may refer to the data set used in inference from the target ML system. In certain cases, a training set may also refer to the tabular data set applied to an initial ML data set transformation process and used to populate a metadata database during processing, and a test set may refer to either a test data set passed to an initial ML data set transformation process in conjunction with the corresponding training set for processing or alternatively to an additional test data set passed to an additional ML data set transformation process for processing.

In some cases, the presentation of categoric feature sets to a target ML system may include prerequisites that the entries in the set be numerically encoded. In some cases, a target ML system may alternatively accept user designation of categoric sets for internal representation of numeric encoding, although such designation may not be required when the categoric feature set is presented to the target ML system already prepared into a numerically encoded form. In some cases, the presentation of categoric features to a target ML system may also include prerequisites that the feature set contain all valid entries, where in practice conventions for representations of missing or invalid data points in raw array or dataframe representations may be achieved with special entries such as “NaN” which stands for “not a number” or other special data types. As used herein, dataframe refers to a common paradigm of tabular data aggregations similar to an array which also include column headers and indexes. In certain cases, these invalid entries may be converted to valid entries based on some convention for missing data infill.

The categoric encodings of FIG. 2 illustrate outputs that may be returned based on a corresponding inputted example source column 202 or 212. An example ‘text’ transformation category 204 is a type of one-hot encoding, where a single column categoric feature set may be converted to a multicolumn boolean integer set, where activations in each column corresponds to inputted entries matching distinct unique values of the categoric feature set. In certain cases, each row of the ‘text’ transformation category 204 may have only one activation, and the illustrated convention for missing data infill is that a row may be returned with zero activations. In some cases other conventions for missing data infill may be applied, for example, adjacent row, arbitrary value, mode value, ML infill, etc., where ML infill may refer to the training of an ML model tied to a single column or multi-column feature set returned from a transformation function to predict infill to a training set feature set and/or a corresponding test set feature set with the model trained on partitioned subsets of the training set. In some cases that ML model may be saved in a metadata database returned from an application for preparing structured data for machine learning. The example ‘1010’ transformation category 206 is a type of binary encoding where a single column categoric feature set may be converted to a multicolumn boolean integer set in which distinct categoric unique values may be represented with a distinct set of zero or more simultaneous activations in a single row, resulting in a reduced memory bandwidth for a categoric encoding vs. one-hot encoding, and where the example convention for missing data infill is that the infill rows may be returned with a distinct set of activations. In some cases, other conventions for missing data infill may be applied. The illustrated ‘ordl’ transformation category 208 is a type of ordinal encoding in which a single column categoric feature set may be converted to a single column where distinct categoric unique values may be represented with distinct integers, with the illustrated convention of integers assignment based on sorted alphabetic order of unique values, and where the illustrated convention for missing data infill is that infill rows may be returned with a distinct integer activation. In some cases, other conventions for missing data infill may be applied. In an alternative configuration for ordinal encoding, the illustrated ‘ord3’ transformation category 210 may be comparable to the ‘ordl’ transformation category with exception of an alternative convention of integer assignment based on sorted order of frequency of unique values followed by alphabetic sorting for unique values with comparable frequencies. The illustrated ‘bnry’ transformation category 214 is a kind of binary encoding, in which a single column categoric feature set with two distinct unique values in addition to any invalid entries may be converted to a multicolumn boolean integer set in which each column corresponds to a distinct unique value of the categoric set for activations, where distinct categoric unique values may be represented with distinct boolean integers, and where the illustrated convention for missing data infill is that a row may be returned with an activation consistent with one of the boolean integers associated with one of the two unique entries, for example the most frequent unique value as illustrated, or alternatively, the least frequent unique value, where the single column binary encoding may serve as a reduced memory bandwidth alternative to one-hot encoding. In some cases, other conventions for missing data infill may be applied.

For the categoric encodings as shown in FIG. 2, the fitting of the returned columns and their associated numeric encodings may be based on the set of entries of a categoric feature set as included in a training set such as to enable a consistent basis of encoding for entries found in a corresponding test set categoric feature set. Here basis of encoding may refer to returning consistent number and order of returned columns with consistent basis for activations to be derived from test set feature set entries as was used as a basis to determine activations derived from training set feature set entries. For each of the categoric encodings shown in FIG. 2, the returned column headers may be based on the inputted column headers with suffix appenders associated with the transformation function. For each of the categoric encodings shown in FIG. 2, the transformations applied to a training set feature set and/or a corresponding test set feature set may be based on transformation functions associated with a transformation category.

FIG. 3 illustrates example outputs based on an example set of inputs to return string parsed encodings for bounded categoric sets 300, in accordance with aspects of the present disclosure. In a categoric feature set, such as illustrated for the collection of strings in the example inputted source column with header ‘address’ 302, the set of entries may be received as strings, where strings are a data type of textual character aggregations, or the entries may be received as other data types such as floats or integers and in some cases may then be converted to string data types. The encoding of such categoric entries by one-hot encoding or variants as illustrated in FIG. 2 would assign a distinct numeric encoding for each unique value, with the resulting representation discarding grammatical structure embedded in the string representations.

The illustrated encodings in FIG. 3 are variations on techniques to automatically extract grammatical structure based on string subset overlaps shared within entries of the categoric feature set. Here the outputs are illustrated based on the example inputted source column with header ‘address’ 302. Generally speaking, the extraction of grammatical structure may be performed by inspecting the set of unique values from the training set categoric feature set, determining the longest string length, then for each entry comparing each subset of that length to every equivalent length subset of the other entries. If string subset composition overlaps are identified, the results may be populated in a data structure matching identified overlaps to their corresponding source column unique values, and for each overlap inspection cycle incrementing the inspection length by negative steps until a minimum length overlap detection threshold is reached. In certain cases, the minimum length overlap detection threshold may be configurable. The populated data structure may then be applied to convert the inputted column to the set of aggregated bins or to consolidate entries to the categoric set based on shared string character subset overlaps. In some cases, the implementation of these transformations may make use of algorithms as shown in Algorithms 1, 2, 3, 4, and/or 5. In some cases, the illustrated encodings in FIG. 3 may be applied to encode an unbounded categoric feature set, such as one with all unique entries or otherwise unbounded.

The illustrated ‘splt’ transformation category 304 is a type of bin aggregation encoding, where a single column categoric feature set may be converted to a multicolumn or single column boolean integer set where activations in each returned column correspond to a distinct identified string character subset overlap found in a comparison between entries of the received categoric feature set. In some cases, the identified string character subset overlap may be included in a suffix appender added to the inputted column header for returned column headers, for example, to identify the target of returned column activations. In another configuration the returned column headers may have a privacy preserving encoding, such as for example with an integer designation suffix appender. In some cases, the type of suffix appender to be applied may be a configurable parameter of the transformation function. As illustrated, identified overlaps may be limited to a single activation per entry, prioritized by the longest length identified overlap. In some case, an overlap may be identified between entries for a string character subset encompassing an entire entry. For entries in which no overlaps are identified or with infill applied, the returned entries may contain no activations. In some cases, other conventions for missing data infill may be applied. In alternate configurations, the activations may be returned in another type of categoric encoding such as one of those shown in FIG. 2.

The illustrated ‘spl2’ transformation category 306 is a type of ordinal consolidation encoding, in which a single column categoric feature set may be converted to an ordinal encoded single column integer set which may contain a reduced number of unique values as compared to the inputted categoric feature set. This consolidation of unique values may be achieved by, for example in cases where two or more of the unique values contain a common identified string character subset overlap, such as those overlaps identified in the ‘splt’ transformation category 304, by replacing each of the received unique value entries with the shorter character length identified overlap. This operation to consolidate the set of unique values may then be followed by an ordinal encoding, for example, which may be an ordinal encoding consistent with the ‘ord3’ as illustrated in FIG. 2. In other configurations, this ordinal encoding may be replaced by another categoric encoding such as one of those illustrated in FIG. 2. In the context of this transformation set being applied in an initial ML data set transformation process, the specification of the steps of transformation, such as a ‘spl2’ to consolidate unique values based on string subset overlaps and a downstream ‘ord3’ to ordinally encode, may be based on transformation functions associated with transformation categories passed to a set of transformation primitives such as primitives shown in Table 1, below. In some cases a similar set of transformation steps may be aggregated into a single transformation function. In some cases, the transformation function associated with the ‘spl2’ transformation category may be applied without the numerical encoding of a downstream categoric transformation function.

The illustrated ‘spl5’ transformation category 308 is another kind of ordinal consolidation encoding, where a single column categoric feature set may be converted to an ordinal encoded single column integer set which may contain a reduced number of unique values as compared to the inputted categoric feature set. The illustrated ‘spl5’ transformation category 308 differs from ‘spl2’ transformation category 306 as for the ‘spl5’ transformation category, entries without an identified overlap are aggregated into a common unique value in the returned encoding. In some cases, the transformation function associated with the ‘spl5’ transformation category may be applied without the numerical encoding of a downstream categoric transformation function. In another configuration another type of categoric encoding other than ordinal may be applied such as one of those shown in FIG. 2. In some cases, a similar set of transformation steps may be aggregated into a single transformation function.

The illustrated ‘spl5’ transformation category 310 is another type of bin aggregation encoding, where a single column categoric set may be converted to a single column or multicolumn boolean integer set where activations in each returned column correspond to a distinct identified string character subset overlap found in comparison between unique values of the received categoric feature set. The illustrated ‘spl5’ transformation category 310 differs from ‘splt’ transformation category 304 as for the ‘spl5’ transformation category, identified overlaps are not limited to a single activation per unique value, which may help allow for more information retention in the encoding but potentially with increased dimensionality. In some cases, identified string character subset overlaps which are only subsets of longer string character subset overlaps identified for the entries may not be recorded as overlaps. For cases where this transformation is applied in the context of an application for preparing structured datasets for machine learning, the use of ML infill to predict infill for invalid entries of the received categoric feature set may train a distinct ML model for each of the returned columns, or in another configuration a single infill ML model may be trained for the aggregation of activation columns. In some cases, the collection of returned columns may be subject to a binary dimensionality reduction, in which each unique set of boolean integer activations in a row may be converted by binary transformation to a unique set of boolean integer activations spread across and resulting in a few number of columns.

For the string parsed encodings for bounded categoric sets such as those shown in FIG. 3, the returned columns and their respective basis for encodings may be derived from entries of a categoric feature set as included in a training set to help enable a consistent basis of encoding for entries found in a corresponding test set feature set. The implementation of these transformations, such as for passing parameters to the string parse transformation functions, may utilize infrastructure in an application for preparing structured datasets for machine learning which allow a user to pass parameters to transformation functions. Such parameters may be tied to a distinct target column or may be set as an update to the defaults for the transformation function. For each of the string parsed encodings shown in FIG. 3, the returned column headers may be based on the inputted column headers with suffix appenders associated with the transformation function. For each of the string parsed encodings shown in FIG. 3, the transformations applied to a training set feature set and/or a corresponding test set feature set may be based on transformation functions associated with a transformation category.

For each of the string parsed encodings for bounded sets as shown in FIG. 3, potential implementations may be distinguished by built in assumptions on whether the set of unique values found in a test set categoric feature set are expected to be a subset of those unique values that may be found in the corresponding training set categoric feature set. For each of the string parsed encodings for bounded sets as shown in FIG. 3, equivalent variants may incorporate assumptions of test set composition in relation to the training set, for example whether the set of unique values found in the test set feature set is expected to be a subset of those values that were found in the corresponding training set feature set. In such cases, those test set feature set entries which do not correspond to training set feature set entries may not be parsed to identify string character subset overlaps, which may have a benefit of increased efficiency of implementation, or alternatively an implementation may conduct string parsing on test set unique entries which were not found in the corresponding training set feature set, such as to return consistent activations or encodings for consistent character subset overlaps that were identified in comparison between the unique values of the training set. More specifically, later demonstrations may refer to transformation categories ‘spl8’/‘spl9’/‘sp10’/‘sp16’, which are comparable to ‘splt’/‘spl2’/‘spl5’/‘sp15’ respectively, but with the added assumption that the set of unique values found in the test set feature set are expected to be a subset of those unique values that were found in the corresponding training set feature set.

Algorithm 1 below is an example algorithm for populating a string parsing overlap dictionary data structure, in accordance with aspects of the present disclosure. For string parsed encodings, such as those illustrated in FIG. 3, the automated algorithmic transformation derived from an inputted categoric feature set to the returned encodings may include a step of populating an overlap dictionary data structure that matches the inputted column unique values with identified string character subset overlaps. Such data structure may be populated in a dictionary with keys of identified overlap substring partitions and associated values of any corresponding inputted unique values, such as the data structure population illustrated in Algorithm 1. In an alternate configuration, a similar data structure may be populated in a dictionary with keys of inputted unique values and associated values of identified string character subset overlaps. Other configurations may populate data structures that make use of a database or graph representations to map identified string character subset overlaps with their associated inputted unique entries.

Algorithm 1

| | |
|---|---|
| 01: | for overlap_length do |

| | |
|---|---|
| 02: | for unique_value do |

| | |
|---|---|
| 03: | for extract do |

| | |
|---|---|
| 04: | for key in overlap_dict do |

| | |
|---|---|
| 05: | if extract in overlap_dict key then |

| | |
|---|---|
| 06: | if concurrent_activations then |

| | |
|---|---|
| 07: | if unique_value in overlap_dict[key] then |

| | |
|---|---|
| 08: | marker true |

| | |
|---|---|
| 09: | end if |

| | |
|---|---|
| 10: | else |

| | |
|---|---|
| 11: | marker true |

| | |
|---|---|
| 12: | end if |

| | |
|---|---|
| 13: | end if |

| | |
|---|---|
| 14: | end for |
| 15: | if not marker then |

| | |
|---|---|
| 16: | for unique_value2 do |

| | |
|---|---|
| 17: | if extract in unique_value2 then |

| | |
|---|---|
| 18: | if extract in overlap_dict then |

| | |
|---|---|
| 19: | if unique_value2 not in overlap_dict[extract] |

then

| | |
|---|---|
| 20: | append unique_value2 to overlap_dict[extract] |

| | |
|---|---|
| 21: | end if |
| 22: | if unique_value not in overlap_dict[extract] then |

| | |
|---|---|
| 23: | append unique_value to overlap_dict[extract] |

| | |
|---|---|
| 24: | end if |

| | |
|---|---|
| 25: | else |

| | |
|---|---|
| 26: | create overlap_dict entry with extract key, |

unique_value, unique_value2 entries

| | |
|---|---|
| 27: | end if |

| | |
|---|---|
| 28: | end if |

| | |
|---|---|
| 29: | end for |

| | |
|---|---|
| 30: | end if |

| | |
|---|---|
| 31: | end for |

| | |
|---|---|
| 32: | end for |

| | |
|---|---|
| 33: | end for |
| 34: | return overlap_dict |

Referring to the example Algorithm 1, above, a for loop from lines 1-33 may be used to cycle through a range of overlap lengths to be inspected. The order of overlap lengths may be sorted in descending order such as to prioritize identifying overlaps with the longest length. The maximum overlap length may be an integer, for example, an integer based on a maximum string length of the inputted categoric feature set unique values. The minimum overlap length may be an integer greater than or equal to 1. The step size between the range of overlap lengths may be an integer greater than or equal to 1. The minimum overlap length, maximum overlap length, and/or step size may be configurable parameters for the transformation function. The for loop of lines 2-32 may be used to cycle through the unique values found in the training set categoric feature set that is the basis of encoding. Such unique values may be converted to strings prior to this operation. The for loop in lines 3-31 may be used to cycle through extracts of the unique values from line 2. The extracts may consist of sequential substring partitions of the unique values of character length based on the overlap length from line 1. For example, for an 8 character unique value and a 6 character overlap length, there may be three extracts for character sets encompassing string index positions 0-5, 1-6, and 2-7. The for loop in lines 4-14 may be used to cycle through keys of an overlap dictionary data structure. The overlap dictionary data structure as illustrated here may be in a form of a dictionary with keys of identified overlap substring partitions and associated values of corresponding inputted unique values, such as unique values that may be aggregated for instance into a list or set. This data structure may be initialized as an empty dictionary prior to line 1, and the keys may have been populated in lines 20, 23, and/or 26. The if statement in lines 5-13 may compare the extract from line 3 to a set of comparable length extracts from the overlap dictionary key from line 4, for example if the overlap dictionary key is an 8 character string and the overlap length from line 1 is 6, the extract from line 3 may be compared to each of the three extracts from the overlap dictionary key for character sets encompassing string index positions 0-5, 1-6, and 2-7. If the extract from line 3 is found to be match one of these overlap dictionary key extracts, the if/else statements of lines 6-12 may be applied. The if statement of line 6 refers to a boolean parameter associated with concurrent activations, such as may be used to distinguish between methods to implement the ‘splt’ verses the ‘sp15’ transformation functions as shown in FIG. 3. In some cases, the concurrent activations parameter option may be omitted. Here, if concurrent activations are allowed, such as may be indicated by a parameter setting of True, the if statement of lines 7-9 may be entered, in which the unique value from line 2 may be checked for presence in the entries of the set of unique values included as a value in the overlap dictionary corresponding to the key from line 4, and if found a marker may be set to True in line 8. This marker, as may have been initialized as False prior to the if statement of line 5, may be used to signal when the extract of line 3 is present in an extract of the overlap dictionary keys found in the comparisons of line 5. If concurrent activations are not allowed per the if statement in line 6, the else statement of lines 10-11 may set the marker to True. In some cases, the marker setting taking place in line 8 or line 10 may be followed by a break command to break out of the for loop of lines 4-14. In some cases, the for loop of lines 4-14 may be omitted, in which case overlaps which are subsets of other identified overlaps may be included in the returned activations. The if statement of lines 15-30 may check the marker and if it is still False may proceed to the for loop of lines 16-29, which may cycle through the unique values found in the training set feature set that is the basis of encoding, the same set of unique values that are being cycled through in the for loop of lines 2-32. The if statement of lines 17-28 may compare the extract from line 3 to a set of comparable length extracts from the unique value from line 16, for example if the unique value from line 16 is an 8 character string and the overlap length from line 1 is 6, the extract from line 3 may be compared to each of the three extracts from the unique value from line 16 for character sets encompassing string index positions 0-5, 1-6, and 2-7. If the extract from line 3 is found to be match one of these extracts, the if/else statements of lines 18-27 may be applied. The line 18 if statement may check for the presence of the extract from line 3 as a key in the overlap dictionary, and if present may enter the if statements of lines 19-24. The if statement of lines 19-21 may check whether the unique value from line 16 is not present in the set of unique values entered as a value in the overlap dictionary corresponding to the key of the extract from line 3, in which case the unique value from line 16 may be appended onto the set of unique values entered as a value in the overlap dictionary corresponding to the key of the extract from line 3 in line 20. In some cases, the operation of line 20 may be followed by a break command to break out of the for loop of lines 16-29, which may improve efficiency for cases where the concurrent activations boolean parameter that may have been inspected in line 6 is set to False. The if statement of lines 22-24 may check whether the unique value from line 2 is not present in the set of unique values entered as a value in the overlap dictionary corresponding to the key of the extract from line 3, in which case the unique value from line 2 may be appended onto the set of unique values entered as a value in the overlap dictionary corresponding to the key of the extract from line 3 in line 23. In some cases, the operation of line 23 may be followed by a break command to break out of the for loop of lines 16-29, which may improve efficiency for cases where the concurrent activations boolean parameter that may have been inspected in line 6 is set to False. The else statement of line 25 may create a new entry to the overlap dictionary with a key of the extract from line 3 and corresponding value of the set of unique values including the unique value from line 2 and the unique value from line 16 in line 26. In some cases, the operation of line 26 may be followed by a break command to break out of the for loop of lines 16-29, which may improve efficiency for cases where the concurrent activations boolean parameter that may have been inspected in line 6 is set to False. The return statement of line 34 may then return the populated overlap dictionary data structure, for example for use to facilitate transformation function activation encodings, where, for example, a new column of activations could be returned for each key of this data structure with activations for entries with those unique values entered as values corresponding to that key. As another example the entries entered in the value set associated with a key may be replaced in the returned set with the associated key as a form of consolidation of entries. In certain cases, one or more of the for loops present in Algorithm 1 may be parallelized.

Algorithm 2

| | |
|---|---|
| 1: | number_iterations = unique_value_length − |
| | overlap_length + 1 |
| 2: | for i in number_iterations do |

| | |
|---|---|
| 3: | extract = unique[i : (overlap_length + i)] |
| 4: | => perform operations with extract |

| | |
|---|---|
| 5: | end for |

Algorithm 2 above is an example algorithm for deriving string partition extracts, in accordance with aspects of the present disclosure. In the comparisons between extracts derived from unique value strings, the sequence for generating extracts may be automated as shown in Algorithm 2. In Algorithm 2, the number of iterations represent the number of extracts derived from a given unique value, where unique value refers to a unique value of the categoric feature set from a training or test set that may be passed to a string parse transformation function and may be converted to string format. As shown in line 1, the number of iterations integer may be derived by subtracting from the length of the target unique value, where length refers to the number of string characters, the overlap length, where overlap length refers to the length of the extracts, and adding 1 to that figure, where the unit addition may be optional depending on convention for how the overlap lengths are initialized. The for loop of lines 2-5 may cycle through the number of iterations, where each iteration is assigned a sequential integer i starting from 0, and applying that integer to partition the unique value string by string index starting from index i through the index derived by adding i to the overlap length. In some cases, the operations performed with the derived extract may be consistent with those discussed for Algorithm 1. In certain cases, one or more of the for loops present in Algorithm 2 may be parallelized.

Algorithm 3

| | |
|---|---|
| 1: | number_iterations = unique_value_length − |
| | overlap_length + 1 |
| 2: | for i in number_iterations do |

| | |
|---|---|
| 3: | extract = unique[i : (overlap_length + i)] |
| 4: | if not space_and_punctuation then |

| | |
|---|---|
| 5: | scrub special characters |

| | |
|---|---|
| 6: | end if |
| 7: | => perform operations with extract |

| | |
|---|---|
| 8: | end for |

Algorithm 3 illustrates a variation on the sequence for generating extracts. The Algorithm 3 variation provides the option to prevent activations from comparisons between extracts in cases where an extract contains special characters. For example, a user may wish to promote single word overlap activations, in which case special characters like spaces or punctuations may not be desired in an activated overlap. This algorithm is similar to Algorithm 2 with the addition of an if statement in lines 4-6. This if statement in line 4 may inspect a space and punctuations parameter, such as may be a boolean marker to activate this option, and if True in line 5 any special characters may be removed from the extract of line 3. This operation relies on, for comparisons between two extracts, having the special characters only scrubbed from one of the two extracts. In certain cases, the special character removal of line 5 may be run as a default without inspecting a space and punctuations parameter in line 4. In some cases, the set of special characters to be excluded may be configurable by a user. In some cases, entries to the set of special characters to exclude may include multi-character strings. In certain cases, one or more of the for loops present in Algorithm 3 may be parallelized.

Algorithm 4

| | |
|---|---|
| 01: | copy overlap_dict keys to test_overlap_dict |
| 02: | for key do |

| | |
|---|---|
| 03: | for unique_value_test do |

| | |
|---|---|
| 04: | for extract do |

| | |
|---|---|
| 05: | if extract == key then |

| | |
|---|---|
| 06: | append unique_value_test to |
| | test_overlap_dict[key] |

| | |
|---|---|
| 07: | end if |

| | |
|---|---|
| 08: | end for |

| | |
|---|---|
| 09: | end for |

| | |
|---|---|
| 10: | end for |
| 11: | return test_overlap_dict |

Algorithm 4 is an example algorithm for populating a string parsing overlap dictionary data structure for a corresponding test set feature set, in accordance with aspects of the present disclosure. When an overlap dictionary is populated, the overlap dictionary may be fit to properties of a training set categoric feature set, such as a training set intended to train a target ML system. In order to perform inference on the target ML system or to generate additional training data, there may be a need to encode test data on a consistent basis, such as to ensure consistent returned columns with activations for identified substring partition overlaps consistent to those derived from the training set. For cases that assume that the set of unique values to be found in a categoric test set feature set are expected to be a subset of those unique values that were found in a corresponding training set categoric feature set, such as those transformation categories noted above as ‘spl8’/‘spl9’/‘sp10’/‘sp16’, there may be no need to populate a string parsing overlap dictionary data structure for a corresponding test set categoric feature set, as the same overlap dictionary can be applied to the test set as was populated for the training set. For cases without this assumption, such as those transformation categories noted above as ‘splt’/‘spl2’/‘spl5’/‘spl5’, there may be a need to populate a string parsing overlap dictionary data structure for a corresponding test set.

The population of a string parsing overlap dictionary data structure for a corresponding test set is illustrated in Algorithm 4. This algorithm demonstration is based on a consistent data structure as discussed above in conjunction with Algorithm 1, where the overlap dictionary entries may have keys of identified overlap substring partitions and associated values of corresponding inputted unique values. In alternate configurations, a similar data structure may be populated in a dictionary with keys of inputted unique values and associated values of identified string character subset overlaps or otherwise entered in a database to map between the two. In line 1 the test overlap dictionary may be initialized with the keys from the corresponding train overlap dictionary, where the values associated with these keys may be initialized with empty sets or lists or in an alternate configuration may be initialized with those unique values that were included as values for the keys in the training set overlap dictionary. The for loop of lines 2-10 cycles through the keys initialized in the test overlap dictionary. The for loop of lines 3-9 cycles through unique values found in the test set categoric feature set, such values as may be converted to strings. The for loop of lines 4-8 cycles through extracts derived from the unique values found in the test set categoric feature set from line 3. The extracts consist of sequential substring partitions based on an overlap length derived from the length of the key from line 2. For example, for an 8 character unique entry and 6 character key length, there may be three extracts for character sets encompassing string index positions 0-5, 1-6, and 2-7. For each of these extracts, in the if statement in lines 5-7 the extract may be compared to the key from line 2, and if consistent then the unique value from line 3 may be appended onto the set of unique values as a value in the test overlap dictionary corresponding to the key from line 2. In certain cases, one or more of the for loops present in Algorithm 4 may be parallelized.

Algorithm 5

| | |
|---|---|
| 01: | for unique_value do |

| | |
|---|---|
| 02: | for unique_value2 do |

| | |
|---|---|
| 03: | if length(unique_value2) > length(unique_value) do |

| | |
|---|---|
| 04: | for extract from unique_value2 do |

| | |
|---|---|
| 05: | if extract == unique_value do |

| | |
|---|---|
| 06: | if extract in overlap_dict do |

| | |
|---|---|
| 07: | if unique_value2 not in overlap_dict[extract] then |

| | |
|---|---|
| 08: | append unique_value2 to overlap_dict[extract] |

| | |
|---|---|
| 09: | end if |

| | |
|---|---|
| 10: | else |

| | |
|---|---|
| 11: | create overlap_dict entry with extract key, |

unique_value, unique_value2 entries

| | |
|---|---|
| 12: | end if |

| | |
|---|---|
| 13: | end if |

| | |
|---|---|
| 14: | end for |

| | |
|---|---|
| 15: | end if |

| | |
|---|---|
| 16: | end for |

| | |
|---|---|
| 17: | end for |
| 18: | return overlap_dict |

Algorithm 5, shown above, is a variation on Algorithm 1 in which instead of comparing string character subsets of unique values to string character subsets of other unique values, string character subsets of unique values are compared to complete character representations of other unique values for identification of overlaps. The for loop of lines 1-17 may be used to cycle through the unique values from a training set categoric feature set. The for loop of lines 2-16 may be used to cycle again through the same unique values from a training set categoric feature set as are being cycled through in lines 1-17. For the configuration shown, the unique value from line 1 may be the complete character representation for overlap detection and the unique value from line 2 may be the subject of extractions for comparison to identify overlaps. In the if statement of lines 3-15, the string character length of the unique value from line 2 may be compared to the string character length of the unique value from line 1 to determine if it is greater, in which case the for loop of lines 4-14 may be used to cycle through extracts of the unique values from line 2, which extracts may be based on an overlap length of the string character length of the unique value from line 1. For example, for an 8 character unique value from line 2 and a 6 character overlap length based on the string character length of the unique value from line 1, there may be three extracts for character sets encompassing string index positions 0-5, 1-6, and 2-7 extracted from the unique value from line 2. The if statement of lines 5-13 may be used to inspect if the extract from line 4 is a string character overlap with the complete character representation of the unique value from line 1, and if so the if/else statements of lines 6-12 may be entered. The line 6 if statement may check for presence of the extract from line 4 as a key in the overlap dictionary and if the extract is present may enter the if statement of lines 7-9. The if statement of lines 7-9 may check whether the unique value from line 2 is not present in the set of unique values entered as a value in the overlap dictionary corresponding to the key of the extract from line 4. In such cases the unique value from line 2 may be appended onto the set of unique values entered as a value in the overlap dictionary corresponding to the key of the extract from line 4. If the if statement in line 6 did not find the extract from line 4 as a key in the overlap dictionary, the line 10 else statement may be applied. The else statement of line 10 may create a new entry to the overlap dictionary with a key of the extract from line 4 and corresponding value of the set of unique values including the unique value from line 1 and the unique value from line 2 in line 11. In certain cases, one or more of the for loops present in Algorithm 5 may be parallelized.

FIG. 4 illustrates example outputs based on an example set of inputs to return string parsed encodings for unbounded categoric sets 400, in accordance with aspects of the present disclosure. Due to the computational cost of automated string parsed encodings as illustrated in FIG. 3, there may be a desire for alternate means of extracting grammatical structure from the entries of a categoric feature set. The example encodings of FIG. 4 achieve their encodings with a lower tier of computational complexity than those demonstrations from FIG. 3, such as may enable more efficient application even on categoric feature sets with all unique entries or which are otherwise unbounded. Here outputs are shown based on an example inputted source column 402 with header ‘address’.

The illustrated ‘nmcm’ transformation category 404 is a type of numerical extraction encoding, where the entries in a single column categoric feature set may be parsed to identify presence of numeric substring partitions. The numeric substring partitions associated with the entries may then be returned in a numeric format in the outputted column. As illustrated, the extracted numeric partitions may be prioritized by longest character length for cases where multiple numeric substring partitions may be present. As illustrated, for cases where no numeric substring is present in an entry, the returned encoding may be populated with an infill, in this example, an infill with the set's mean. In some cases, other conventions for missing data infill may be applied. In some cases, the evaluation of numeric substring partitions may recognize different numeric formats, such as numbers with or without presence of commas, periods, or spaces as may be a convention in different regions. The implementation of this encoding may use a function that tests string extracts to determine if they are valid numerical entries. The implementation of this encoding may use a data structure that maps identified numeric partitions to their associated categoric feature set unique values. The implementation of the encoding may make use of a descending sorted list of character lengths for deriving string extracts to test, for example for an 8 character entry and a 6 character length there may be three extracts tested for numeric validity for character sets encompassing string index positions 0-5, 1-6, and 2-7, where if numeric partitions are not identified the character length may then be decremented to a smaller integer for testing. The illustrated ‘nmc2’ transformation category 406 is comparable to ‘nmcm’ with the addition of a downstream z-score normalization by a nmbr transformation function. The illustrated ‘nmc3’ transformation category 408 is comparable to ‘nmcm’ with the addition of a downstream min-max scaling normalization by a mnmx transformation function. In alternate configurations a downstream normalization may be applied by other types of transformation functions, or other types of downstream transformation functions may be applied such as for example numeric transformations, bin aggregations, or categoric encodings. In the context of these transformation sets being applied in an initial ML data set transformation process, the specification of the steps of transformation, such as a nmcm to extract numeric substring partitions and a downstream nmbr for z-score normalization or mnmx for min-max scaling, may be based on transformation functions associated with transformation categories passed to a set of transformation primitives such as primitives illustrated below in Table 1. In some cases, a similar set of transformation steps may be aggregated into a single transformation function. In an alternate configuration, comparable methods may be applied to extract non-numeric character sets.

The illustrated ‘srch’ transformation category 410 is another technique to extract grammatical context from categoric feature sets that may be efficiently applied even to unbounded sets by searching categoric entries for one or more specified search terms, which may then be encoded with a distinct column for activations associated with each search term for cases where that search term was found to be present as a string character subset of a received entry to the categoric feature set. In some cases, the subset triggering an activation may encompass the string characters of an entire entry. In some cases, zero, one, or more of these columns may have simultaneous activations in a row. As in this demonstration, the search terms may be passed to the transformation function as a parameter. In some cases, entries to the list of search terms parameter may be passed as an embedded list of search terms such that the search terms in this passed list entry to the list of search terms may have activations aggregated into a single column. The implementation of the encoding may make use of character lengths based on search term string lengths for deriving string extracts from the categoric feature set entries to test, for example for an 8 character entry and a 6 character search term length there may be three extracts compared to the search term for character sets encompassing string index positions 0-5, 1-6, and 2-7. For cases where this transformation is applied in the context of an application for preparing structured datasets for machine learning, the use of machine learning to predict infill for invalid entries of the received categoric feature set may train a distinct machine learning model for each of the returned columns, or in another configuration a single infill model may be trained for the aggregation of activation columns. The illustrated ‘srch’ transformation 410 shows an example output corresponding to an example set of search terms being passed to the transformation function with a distinct column for activations associated with each search term. In some cases, when a search term is not found present as a string character subset of any entries, the column for activations may be omitted from the returned set. The implementation of this encoding may use a data structure that maps identified search terms to their associated categoric feature set unique values, or in another configuration the set of activations may directly serve as the populated data structure mapping search terms to their associated feature set unique values.

The illustrated ‘src4’ transformation category 412 is a variation on ‘srch’ transformation category 410 where the encoding of the activations is returned in an ordinal integer representation instead of column activations. For this variation there may only be a single activation returned per row even for cases where more than one of the search terms was present in an entry. In certain cases, there may be a convention for giving precedence to search terms, such as giving precedence to search term entries toward the beginning or end of the passed parameter of search terms. In another configuration, another type of categoric encoding could be applied instead of ordinal.

For each of the string parsed encodings for unbounded categoric sets as illustrated in FIG. 4, the fitting of the returned columns and their associated numeric encodings may be based on entries of a categoric feature set as included in a training set such as to enable a consistent basis of encoding for entries found in a corresponding test set feature set. The implementation of these transformations, such as for passing search term parameters to the ‘srch’ function 410, may make use of infrastructure in an application for preparing structured datasets for machine learning which allow a user to pass parameters to transformation functions, which parameters may be tied to a distinct target column or may be set as an update to the defaults for the transformation function. For each of the string parsed encodings as illustrated in FIG. 4, the returned column headers may be based on the inputted column headers with suffix appenders associated with the transformation function. In some cases, the transformations for unbounded categoric sets illustrated in FIG. 4 may be applied to encode k bounded categoric feature sets. For each of the string parsed encodings as illustrated in FIG. 4, the transformations applied to a training set feature set and/or a corresponding test set feature set may be based on transformation functions associated with a transformation category.

FIG. 5 is a graph diagram of transformation function application from a transformation tree aggregation of string parsed encodings for bounded categoric sets 500, in accordance with aspects of the present disclosure. For bounded categoric feature sets of unknown composition, there may be a desire to automatically prepare the sets for machine learning in a fashion that retains a distinct encoding for each unique value while also allowing for the extraction of grammatical structure from comparisons between the unique values. What is needed is a technique to apply a set of transformations that present the categoric feature set to machine learning in multiple configurations, such as configurations of varying information content, which preparations may include generations and branches of derivations. FIG. 5 illustrates an example of such transformation function aggregations for root categories ‘or19’ 502 and ‘or20’ 510. Here a diagram for root category 502 can be interpreted as flowing from the top of the diagram representing a root category 502 identified for an inputted source column 504 progressing downward through branches of transformation functions 506 applied to generate the set of returned columns 508. Here the inputted column 504 represents the target categoric feature set which for this demonstration is received with an example column header ‘column’, and the four character keys in the transformation trees 506 and 512 represent transformation functions associated with transformation categories that may be entries to sets of transformation primitives for specification of the order of derivations associated with a root category, such as may be used in an application for preparing structured datasets for machine learning. As illustrated in 508 and 514, the application of these transformation functions may be recorded in the returned sets by way of suffix appenders attached to the received column headers, for example the returned column ‘column_UPCS_nmc7_nmbr’ may be the result of applying to the received column ‘column’ the sequential set of transformation functions UPCS, nmc7, and nmbr in that order. In some cases the transformation functions applied may be distinguished between those functions targeting a training or test set feature set, targeting a training set feature set and a corresponding test set feature set, or a corresponding function targeting a test set feature set such as may apply a basis derived from a training set feature set stored in a metadata database in an application for preparing structured datasets for machine learning. In some cases, the illustrated transformation trees 506 and/or 512 may be applied to encode an unbounded categoric feature set, such as one with all unique entries or otherwise unbounded.

The root category ‘or19’ 502 receives the categoric feature set column 504 and applies a transformation tree 506 including upstream transformation functions UPCS and NArw. Here UPCS refers to a function to convert all string entries to uppercase characters, such as may allow for consistent interpretation of received entries which are consistent in character composition but with different case configurations, for example UPCS would allow for consistent categoric encodings between received categoric string entries ‘usa’, ‘Usa’, and ‘USA’, which would all be returned as ‘USA’. In some cases, the UPCS transformation function may accept a parameter to turn off this case conversion. Here the NArw transformation refers to a function that returns a single column of boolean integer activations indicating presence of entries that were subject to infill for missing or improperly formatted data. In some cases, the designation of the types of data that will be targets for infill may have been based on entries to a data structure corresponding to the root category. In some cases, an application for preparing structured datasets for machine learning may accept a parameter to turn on or off the default inclusion of NArw transformation functions as upstream primitive entries. Here the 1010 transformation function refers to a categoric encoding which may be consistent with the transformation function associated with the ‘1010’ transformation category as illustrated in FIG. 2. Here the nmc7 transformation function followed by a nmbr transformation function may be similar to the transformation functions associated with the ‘nmcm’ transformation category including the nmcm transformation function followed by a nmbr transformation function for z-score normalization illustrated in FIG. 4, with the distinction that nmc7 may differ from nmcm in that it may have a more efficient method for parsing test set entries by taking account for redundancy with entries that were found in the training set. Here the spl9 and sp10 transformation functions may be similar to the transformation functions associated with the ‘spl2’ and ‘spl5’ transformation categories respectively as illustrated in FIG. 3 with additional assumptions of test set composition in relation to the training set for efficiency. Here the ord3 transformation function may be consistent with the transformation function associated with the ‘ord3’ transformation category as illustrated in FIG. 2.

The illustrated root category ‘or20’ 510 is similar the ‘or19’ root category 502 but with an additional tier of spl9 performed prior to the sp10, with an ord3 categoric encoding downstream of that second spl9 in the ‘or20’ transformation tree 512. In alternate configurations, further additional tiers of spl9 may be inserted prior to the sp10.

In alternate configurations of the root categories 502 and/or 510 illustrated in FIG. 5, some of these transformation functions may be replaced or omitted, either individually or in aggregate. For example, a similar set of transformations may omit the UPCS transformation function or it may be replaced with a transformation function that converts strings to lowercase characters for comparable effect. In some cases, the NArw may be omitted. In some cases, the 1010 and/or ord3 categoric encodings may be replaced with another kind of categoric encoding, such as for example one of the categoric encodings illustrated in FIG. 2. In some cases, the nmc7 may be omitted or replaced with another kind of numeric extraction transformation function such as for example nmcm as illustrated in FIG. 4. In some cases, the nmc7 may be followed by additional transformations and/or binned aggregations prior to any nmbr normalization. In some cases, the nmbr normalization may be omitted or replaced with another kind of normalization, such as for example the mnmx normalization as illustrated with the ‘nmc3’ transformation category in FIG. 4. In some cases, the nmbr normalization may be replaced by a categoric encoding, such as for example one of the categoric encodings illustrated in FIG. 2. In some cases, the spl9 and/or sp10 transformation functions may be replaced with variants that parse test set entries that were not present in the training set, such as spl2 and/or spl5. In some cases, the branch starting at spl9 may be omitted and replaced with a string parsing transformation with binned aggregations, such as for example splt, spl8, sp15, or sp16. In some cases, the sp10 may be replaced with a spl2, spl9, or a string parsing transformation with binned aggregations. In some cases, variations on this transformation tree may be achieved by defining new root categories, and in other cases these variations may be achieved by overwriting transformation primitive entries such as in the context of workflows making use of an application for preparing structured datasets for machine learning. In some cases, additional other transformation functions, such as for example the srch transformation function, or branches of multiple other transformation functions may be added to this transformation tree, such as for application to the source column or for application one of the other generated columns. In some cases, variations on this transformation tree may incorporate custom transformation functions defined by a user and passed to an application for preparing structured datasets for machine learning. In some cases, a portion or all of these transformations may be aggregated into a single transformation function.

FIG. 6 illustrates example outputs based on an example set of inputs to return a transformation tree aggregation of string parsed encodings for bounded categoric sets 600, in accordance with aspects of the present disclosure. The illustrated output for an example inputted source column 602 is based on applying an ‘or19’ root category 604, such as the ‘or19’ with transformation function applied as illustrated in FIG. 5. In this example, the inputted source column header is ‘address’ instead of ‘column’ as shown in the example in FIG. 5, so the returned column headers differ accordingly. In this example, the returned column ‘address_UPCS_nmc7_nmbr’ 606 is illustrated as consisting of a set of normalized numerical float data types with infill to missing points representing the set's mean, derived by applying a nmbr transformation function to the output of a nmc7 transformation function applied to the output of an UPCS transformation function applied to an example inputted source column 602 with header ‘address’. Here the set of returned columns 608 comprise the set of ‘address_UPCS_1010_0’, ‘address_UPCS_1010_1’, ‘address_UPCS_1010_2’, and ‘address_UPCS_1010_3’ and consist of a set of boolean integers in which distinct encodings may be represented by a distinct set of zero, one, or multiple simultaneous activations in a row, derived from the application of a 1010 transformation function applied to the output of an UPCS transformation function applied to an example inputted source column 602 with header ‘address’. Here the returned column ‘address_UPCS_spl9_ord3’ 610 represents an ord3 transformation function for ordinal integer encoding applied to the output of a spl9 transformation function applied to the output of an UPCS transformation function applied to an example inputted source column 602 with header ‘address’. The returned column ‘address_UPCS_spl9_sp10_ord3’ 612 represents an ord3 transformation function for ordinal integer encoding applied to the output of a sp10 transformation function applied to the output of a spl9 transformation function applied to the output of an UPCS transformation function applied to an example inputted source column 602 with header ‘address’. Here the returned column ‘address_NArw’ 614 represents a NArw transformation function for boolean integer activations indicating presence of infill for the received value from the example inputted source column 602, here activated for the entry ‘None’ which is a special data type that may require infill.

For the transformation tree aggregation of string parsed encodings for bounded categoric sets illustrated in FIG. 6, the fitting of the returned columns and their associated numeric encodings may be based on the set of entries of a categoric feature set as included in a designated training set such as to enable a consistent basis of encoding for entries found in a corresponding test set feature set. The implementation of these transformations, such as for passing parameters to the string parse transformation functions, may make use of infrastructure in an application for preparing structured datasets for machine learning which allow a user to pass parameters to transformation functions, which parameters may be tied to a distinct target column or may be set as an update to the defaults for the transformation function. For each of the categoric encodings as illustrated in FIG. 6, the returned column headers may be based on the inputted column headers with suffix appenders associated with the transformation function.

In accordance with aspects of the present disclosure, one or more transformations and an order in which to apply the transformations may be based on a predefined transformation tree utilizing defined transformation category entries assigned for each root category's transformation primitives. In certain cases, portions of the transformation tree may be defined based on information provided by the user. For example, root category transformation tree primitive entries of transformation categories and/or their associated transformation functions may be defined for incorporation of custom transformations or custom sets of transformations into an application for preparing structured datasets for machine learning, for example, by a user. In certain cases, default automated root categories of transformations to be applied based on evaluated data properties of the columns may be user assigned. Table 1 below illustrates an example set of transformation primitives.

TABLE 1

| | Upstream/ | Generation | Column | Downstream |
|---|---|---|---|---|
| Primitive | Downstream | applied to | Action | Offspring |
| parents | Upstream | First | Replace | Yes |
| siblings | Upstream | First | Supplement | Yes |
| auntsuncles | Upstream | First | Replace | No |
| cousins | Upstream | First | Supplement | No |
| children | Downstream | Offspring | Replace | Yes |
| | parents | | | |
| niecesnephews | Downstream | Offspring | Supplement | Yes |
| | siblings | | | |
| coworkers | Downstream | Offspring | Replace | No |
| | auntsuncles | | | |
| friends | Downstream | Offspring | Supplement | No |
| | cousins | | | |

TABLE 2
Root Category

| Upstream | | Downstream | |
|---|---|---|---|
| Primitives: | Entries: | Primitives: | Entries: |
| parents | Category Entries | children | Category Entries |
| siblings | Category Entries | niecesnephews | Category Entries |
| auntsuncles | Category Entries | coworkers | Category Entries |
| cousins | Category Entries | friends | Category Entries |

As an example, for a given root category, each primitive may be defined to contain entries of zero or more transformation categories. Table 2 above illustrates an example of how these transformation category entries may be populated in a root category's transformation tree. Each category may have its own defined transformation tree, such that for a given root category, a set of transformations associated with upstream primitives are applied to the column associated with the root category. Where the upstream primitive category entry includes downstream offspring in that category's transformation tree, the downstream offspring categories are identified from the respective transformation tree of the upstream primitive category entry. Additional downstream offspring category entries of the downstream offspring categories may be similarly identified, and transformation functions associated with the one or more levels of downstream offspring are applied to the column returned from preceding upstream primitives with offspring category entry from which the offspring primitive category entries were derived. Where a category of transformation is applied with a Supplement primitive the preceding column upon which the transformation is applied may be left in place unaltered. Where a category of transformation is applied associated with a Replace primitive, the column upon which the transformation is applied may be subject to a deletion operation which may include maintenance of the metadata data for this and associated columns. In this example a root category may be populated as an entry in a primitive of its own transformation tree, for example the transformation function associated with the root category used to access the initial generation of transformation tree for a column may not be applied to the column unless that root category is populated as an entry to one of the primitives of its own transformation tree.

With respect to transformation functions associated with a transformation category, a category may make use of different types of transformation functions depending on which data sets are to be targeted. For example, transformation functions may derive properties from a training set column for processing that column, transformation functions may use properties derived from a previously processed, corresponding training set column to subsequently process a test set column, transformation functions may process both a corresponding training and test set column based on properties derived from the training set column in application, or transformation functions may independently process either a training set column or test set column without the use of properties derived from a training set column. The training set properties for consistent processing between training and test sets with these transformation functions may be accessed from the metadata database or alternatively derived from the training set during application of a transformation function. Transformation functions may return a set of columns with zero, one, or more columns. A user may also define and pass custom transformation functions making use of consistent metadata assembly methods. In some cases, transformation functions may accept transformation function specific parameters from a user. In some cases, the set of transformation functions associated with a transformation category may also include an inversion transformation function, which may be suitable to perform an inverse transform corresponding to the forward transform of the other transformation functions associated with the transformation category. The inversion transformation function, thus, may be applied to recover the form of data originally received in an ML data set transformation process. For example, an inversion transformation function may be used to recover the original form of labels after an ML prediction is generated or may be used to recover the original form of training or test data after processing in an ML data set transformation process.

FIGS. 7A and 7B illustrate an example of a transformation function specification 750 for a transformation tree 700 aggregation of string parsed encodings for bounded categoric sets, in accordance with aspects of the present disclosure. Here the illustrated ‘or19’ root category transformation tree 700 may be similar to those shown above with respect to FIG. 5 and FIG. 6, and example entries to the data structures for transformation function specification 750 are shown corresponding to the transformation tree 700. Here the four character strings represent one of either: a root category 754, as may be a key for accessing entries in a “transformdict” data structure 756 and accessing entries in a “processdict” data structure 758; the root category shown at the header of the graph diagram of transformation function applications 700; a transformation category, as shown as entries to the transformation primitives in the transformdict data structure 756; or transformation functions, as shown as entries to the processdict data structure 758 as well as aggregated in the graph diagram of transformation function application 700. Here the single transformation function entries to the processdict data structure 758 and each entry in the graph diagram of transformation function applications 700 are an abstraction for the set of transformation functions intended for application to train and/or test sets.

Here the transformdict data structure 756 may refer to a dictionary with root categories as keys and values of an embedded dictionary with transformation primitives as keys and values as lists or sets of transformation category entries. In some cases, the transformdict may be populated in some other type of database capturing relationships between root categories and transformation primitive entries. Here the processdict data structure 758 may refer to a dictionary with transformation categories as keys and values of an embedded dictionary with keys of transformation function types and values of the associated transformation functions. Here the single transformation function entry to the processdict data structure 758 is an abstraction for the set of transformation functions as may be directed to a training set feature set and/or a test set feature set. In some cases the processdict data structure may contain additional entries associated with a transformation category, for example, a classification of the type of values that will be a target for infill, a classification of the type of predictive algorithms that may be applied to predict infill with ML infill, an indication of information retention extent of any inversion transformation function, and/or an indication of target label category for transformation sets returned in multiple configurations for cases where the transformation category is applied as root category to a label column in conjunction with a feature importance evaluation. In some cases, the processdict may be populated in some other type of database capturing relationships between root categories and associated transformation functions.

In the context of a ML data set transformation process, when the ‘or19’ root category is assigned to a column, such as either may be assigned based on an automated evaluation of feature set properties or based on user assignment, the type and order of transformation functions applied to the inputted column may be determined by transformation functions associated with transformation category entries to a set of transformation primitives for a root category. For example, in FIG. 7 where a root category of ‘or19’ is applied to the inputted categoric feature set column, the upstream primitive entries are inspected where is found entries to the parents and cousins primitive. The ‘NArw’ entry to the cousins primitive applies the NArw transformation function from the processdict entry associated with the ‘NArw’ transformation category, and because cousins is a primitive without offspring no inspection of the ‘NArw’ downstream primitives is conducted. The ‘or19’ entry to the parents primitive applies the UPCS transformation function from the processdict entry associated with the ‘or19’ transformation category, and because parents is a primitive with offspring the downstream primitive entries associated with the ‘or19’ root category are inspected, where downstream primitive entries are identified for children, nieces nephews, and coworkers primitives, which are applied to the set returned from the UPCS transformation associated with the ‘or19’ primitive entry from which they were spawned. These downstream primitive entries are then treated as the upstream primitive entries for the successive generation, for example children are treated as parents, nieces nephews as siblings, coworkers as aunts uncles, and friends as cousins. The progression of transformation functions 700 are presented for the remainder of the transformations associated with the ‘or19’ root category in FIG. 7 corresponding to the example transformdict 756 and processdict 758 entries. Here, transformation category entries to the transformation primitives in the transformdict 756 which are highlighted in light grey indicate transformation categories whose output is not retained in the returned set due to a downstream primitive entry to a replacement primitive. Transformation category entries which are highlighted in dark grey indicate transformation categories that are included in the returned set due to no downstream replacement primitive entries performed. Transformation categories which are not highlighted include those entries that are not inspected. In some cases, the friends primitive entry to the ‘nmbr’ root category and/or the cousins primitive entry to the ‘or19’ root category may be activated or deactivated by an external parameter in the context of a ML data set transformation process.

FIG. 8 is a flow diagram illustrating a technique for processing data in an initial ML data set transformation process and consistently processing additional data in an additional ML data set transformation process 800, in accordance with aspects of the present disclosure. At block 802, a tabular training data set is received, the training data set including a set of one or more source columns. This training data set may be passed in, for example, as a file, set of files, references, or another input format. The training data may be organized as a table, with a specific observation of the training data in each row, along with multiple associated feature columns with a single column per feature. For example, the training data may include one or more columns defining aspects of the data set and include cells containing data items. In certain cases, an additional test data set, such as a test data set which may have a consistent number and order of source columns, may be received as well for processing on the training set basis. In some cases, only a training set may be received. At block 804, column labels are identified from the training data set, the column labels associated with a received column of data points. In certain cases when column labels are not included in the training data set, column labels may be assigned based on order of the columns. In certain cases, the data sets may include one or more columns designated as label columns for a training operation. These label columns generally identify a specific aspect of the feature a target ML system may be trained on. As an example, for features such as a collection of house properties, the label may be the price of house sale transactions. Thus, the labels define the ground truth associated with the set of features. In certain cases, the label columns may be included as adjoined designated columns to training and/or test data sets. In certain cases where labels may not be available, labels may be automatically designated, for example, via a pattern or based on defined permutations of features. Other columns may be defined, such as an identifier index column and/or other desired pass-through columns. In certain cases, certain columns, such as the identifier index column and/or other desired pass-through columns, may be preserved as unedited, read-only columns in a set which may serve as a store for columns which are to be excluded from transformations other than partitioning for validation sets and/or row correspondence maintenance consistent to the corresponding train or test from which they were extracted, and excluded from deriving infill or feature importance with predictive models.

At block 806 for an identified column label, a root category is determined based on at least one of a user assignment, data types, or distribution properties associated with the data points of the received column from the set of source columns. For example, a user may provide pre-determined or specified root categories for columns of the set of source columns, such as via a configuration file, command arguments, etc. As another example, when a user assignment is not provided, an evaluation function may be applied to a source column which derives a root category for automated assignment based on an assessment of data properties in the received source column. In some cases, such as when an initial data set transformation process is designed for a single specific type of transformation, the assignment of a root category may default to a single type, in which case block 806 may be omitted.

At block 808, one or more data transformations are performed for data points in the received column, the one or more data transformations for extracting a grammatical structure shared between entries of a categoric feature set to obtain a transformed data set. For example, the grammatical structure may refer to patterns which may be embedded in the data, such as common string partition subset overlaps, prefix or suffix, character types, identifying presence of search terms, spacing, and the like. This extracted grammatical structure may be used, for example, for assembling aggregations between entries, data infill, or transformations. In certain cases, entries in the column, or across columns, may be parsed and compared such as to identify character subset overlaps as between entries, identify numeric string subset partitions from entries, identify presence of search terms in entries, etc. These activations may be identified and included in the transformed data set. Additional feature engineering transformations may also be applied. Feature engineering generally prepares a data set for use with ML systems by, for example, processing the training data set and/or test data sets into formats that can be readily or more efficiently used by ML systems by shaping or encoding the data sets through one or more data transformations. In certain cases, the feature engineering techniques may be based on the determined root categories, or may be defined based on, for example, user input, such as a set of input arguments. Multiple transformations may also be applied based on transformation functions associated with transformation category entries to a transformation tree family of primitives associated with a root category. The transformation tree families may be predefined or based on user inputs. These feature engineering transformations may be pulled from a library of feature transformations and may include transformations, for example, for numeric, sequential, categoric, and/or data-time data types. As an example, one hot encoding may spread the categories in a column to multiple columns and assign a binary value to each cell of the columns based on the categoric entries in a training set feature set. As another example, for numerical data, z-score normalization based on the mean and standard deviation of numeric entries in the training set feature set may be applied. As another example, z-score normalization may be supplemented by adding one or more columns containing binned Boolean identifiers indicating standard deviations of a particular value from a mean value of the training set. In certain cases, user provided sets of transformations may also be applied, which may incorporate transformation functions from a built-in library and may also incorporate user defined transformation functions. The feature engineering methods may also incorporate a preliminary infill technique, for example, to facilitate subsequent training of a predictive model for ML infill derivations.

In some cases, the application of data transformations in block 808 may be supported by transformations associated with missing data infill, which may be automated or based on user specification for the type of infill to be applied. In some cases, such application of missing data infill may be supported by an assessment of entries in a column to identify those appropriate as infill targets. In some cases, a user may designate additional types of data associated with a column or associated with a transformation category which are to be targets for infill. In some cases, the infill may be performed by ML infill in which machine learning models trained on partitioned subsets of a training data set are applied to predict infill to training and/or test data set feature sets. Other examples of infill options may include imputation with a specific value, such as zero, one, NaN, or another target value; an imputation with a value derived from a training set such as a mean, median, mode, or least common value, or an adjacent cell infill.

In some cases, the application of data transformations in block 808 may be followed by a feature importance evaluation, in which a machine learning model is trained on training data and a label column or test data and a label column, and distinct columns or sets of columns are shuffled to evaluate impact to the model's predictive accuracy with such impact serving as a metric for feature importance. In some cases, the application of data transformations in block 808 may include one or more types of dimensionality reduction, for example, to aggregate numeric columns by principle component analysis, aggregate boolean integer columns by a binary encoding, and/or to trim columns based on the results of a feature importance evaluation. In some cases, the data transformations in block 808 may include a shuffling operation to randomize the order of rows. Such shuffling operation may be consistently applied to maintain row correspondence between train, test, or validation sets and any corresponding label sets and/or index sets. In some cases, the data transformations of block 808 may include an oversampling operation in which rows with underrepresented label classes are duplicated in the returned sets to even out the frequency of label class representations for training a target ML system. Such oversampling operation may be consistently applied to maintain row correspondence between train, test, or validation sets and any corresponding label sets and/or index sets.

At block 810, the column root categories determined for each identified column label and properties of the data transformations performed for each source column are recorded in a metadata database. Information indicating the feature engineering techniques applied to the columns and any parameters used to apply those techniques are output as a part of the metadata database. Saving and outputting the metadata database helps allow for consistent processing between multiple datasets across multiple runs and timeframes. For example, an initial training data set and, in some cases, an initial test data set may be processed for initially training a ML system. Once the ML system is trained, additional data may be provided to the ML system to, for example, generate predictions using the ML system. Additional data may be collected after training and this later acquired data may be processed in a manner similar to the initial training data sets to provide a constant and consistently formatted data for the ML system, such as to train a new ML system with consistently formatted data to iterate on the ML system techniques in isolation of random noise effects of data set processing, or to generate predictions from the trained ML system.

At block 812, the metadata database and transformed training data set for training a ML system may be outputted. For example, the transformed training data set may then be used as a training set for a target ML system. In some cases, the returned metadata database may be outputted by way of storing in an associated database, in some cases, the metadata database may be returned to the user for external storage, and in some cases both may take place.

At block 814, a tabular additional data set and the metadata database are received. For example, a user may submit another data set, such as an additional training data set, test data set, etc., for transformation, such as to fill out or expand the data set, or for generating predictions from a target ML system trained on the training data used as a basis for the metadata database. The metadata database provides information regarding the transformations applied as to the training data set and may be used to determine transformations to apply to the additional training data set. In certain cases, determinations as to what specific forms of transformations may have been made and/or trained ML systems may have been created to apply to certain portions of the data set and the metadata database helps to ensure consistent transformations as across data sets by providing information as to these previously applied transformations. At block 816, one or more data transformations may be performed for data points in corresponding additional columns of the tabular additional data set using the recorded column categories and properties of the data transformations from the metadata database to obtain a transformed additional data set using the same basis of transformations as were applied to the tabular training data set returned in block 812. For example, the metadata database may be read, and the transformations indicated in the metadata database may be applied to the additional data set. At block 818, the transformed additional data set is output for use with a target ML system.

In an alternate configuration, the population of the metadata database to record basis of transformations may be performed without application of transformations to a tabular training data set in block 808, in which case only the metadata database would be returned in block 812, and where the application of the transformations to a training data set may then be performed by passing the training data set as an additional data set with the metadata database as the inputs of block 814.

FIG. 9 is a block diagram of an embodiment of a computing device 900, in accordance with aspects of the present disclosure. As illustrated in FIG. 9, device 900 includes a processing element such as processor 905 that contains one or more hardware processors, where each hardware processor may have a single processor core or multiple processor cores. Examples of processors include, but are not limited to, a central processing unit (CPU) or a microprocessor. Although not illustrated in FIG. 9, the processing elements that make up processor 905 may also include one or more other types of hardware processing components, such as graphics processing units (GPUs), tensor processing units (TPUs), application specific integrated circuits (ASICs), field-programmable gate arrays (FPGAs), digital signal processors (DSPs), and/or quantum computing processors such as for example quantum annealing devices, noisy intermediate-scale quantum (NISQ) devices, or fault tolerant quantum computing devices. Generally, device 900 may perform any of the functionality described above (e.g., in conjunction with FIGS. 1-8).

FIG. 9 illustrates that memory 910 may be operatively and communicatively coupled to processor 905. Memory 910 may be a non-transitory computer readable storage medium configured to store various types of data. For example, memory 910 may include one or more volatile devices such as random access memory (RAM). The memory 910 for quantum computing devices (QRAM) may include a pre-trained generative model and/or a low depth circuit for accessing data in a quantum superposition. Non-volatile storage devices 920 can include one or more disk drives, optical drives, solid-state drives (SSDs), tap drives, flash memory, electrically programmable read only memory (EEPROM), and/or any other type memory designed to maintain data for a duration time after a power loss or shut down operation. The non-volatile storage devices 920 may also be used to store programs that are loaded into the RAM when such programs executed.

Software programs may be developed, encoded, and compiled in a variety of computing languages for a variety of software platforms and/or operating systems and subsequently loaded and executed by processor 905. In one embodiment, the compiling process of the software program may transform program code written in a programming language to another computer language such that the processor 905 is able to execute the programming code. For example, the compiling process of the software program may generate an executable program that provides encoded instructions (e.g., machine code instructions) for processor 905 to accomplish specific, non-generic, particular computing functions. In certain cases, the software program may be configured for parallelized operations, for example on a GPU, co-processor, ML processor, quantum computing processor, or other processor provided in addition to processor 905.

After the compiling process, the encoded instructions may then be loaded as computer executable instructions or process steps to processor 905 from storage 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900. Storage 920 may be partitioned or split into multiple sections that may be accessed by different software programs. For example, storage 920 may include a section designated for specific purposes, such as storing program instructions or data for updating software of the computing device 900. In one embodiment, the software to be updated includes the ROM, or firmware, of the computing device. In certain cases, the computing device 900 may include multiple operating systems. For example, the computing device 900 may include a general-purpose operating system which is utilized for normal operations.

In certain cases, elements coupled to the processor may be included on hardware shared with the processor. For example, the communications interfaces 925, storage 920, and memory 910 may be included, along with other elements such as a digital radio, in a single chip or package, such as in a system on a chip (SOC). Computing device may also include input devices 930 and/or output devices, not shown, examples of which include sensors, cameras, human input devices, such as mouse, keyboard, touchscreen, monitors, display screen, tactile or motion generators, speakers, lights, etc. Processed input, for example from a sensor input device 930, may be output from the computing device 900 via the communications interfaces 925 to one or more other devices.

What is claimed is:

1. A method for consistently preparing data for a machine learning (ML) system, comprising:
receiving a tabular training data set, the training data set including a set of one or more source columns;
identifying column labels from the tabular training data set, the column labels associated with a received column of data points from the set of source columns;
determining, for an identified column label, a root category based on at least one of a user specification, data types, or distribution properties associated with the data points in the received column from the set of source columns;
performing one or more data transformations for data points in the received column, the one or more data transformations for extracting a grammatical structure shared between entries of a categoric feature set to obtain a transformed data set;
recording column categories determined for each identified column label and properties of the data transformations performed for each source column in a metadata database;
outputting the metadata database and transformed training data set for training a ML system;
receiving a tabular additional data set and the metadata database;
performing the one or more data transformations for data points in corresponding additional columns of the tabular additional data set using the recorded column categories and properties of the data transformations from the metadata database to obtain a transformed additional data set; and
outputting the transformed additional data set for use with the ML system.

2. The method of claim 1, wherein the data transformations for extracting the grammatical structure comprise:
comparing string character subsets of entries to string character subsets of other entries;
identifying overlaps shared between string character subsets of entries; and
returning one or more returned columns with activations corresponding to identified overlaps from received entries of the categoric feature set.

3. The method of claim 1, wherein the data transformations for extracting the grammatical structure comprise:
comparing string character subsets of entries to string character subsets of other entries;
identifying overlaps shared between string character subsets of entries; and
returning a returned column with entries from the categoric feature set consolidated into a fewer number of unique values according to the identified overlaps.

4. The method of claim 1, wherein the data transformations for extracting the grammatical structure comprise:
inspecting string character subset extracts of entries;
checking validity of the extracts as numeric character sets; and
returning a returned column with extracted numeric entries.

5. The method of claim 1, wherein the data transformations for extracting the grammatical structure comprise:
receiving one or more search terms as a parameter to a transformation function; and
returning one or more returned columns with activations associated with identified search terms present as string character subsets in the entries of the categoric feature set.

6. The method of claim 1, wherein the data transformations for extracting the grammatical structure comprise:
performing one or more data transformations for data points in a received column in an order based on defined primitives of a transformation tree to obtain a transformed data set, the transformation tree including defined primitive category entries associated with each root category, wherein the defined primitives associated with the received column are based on a root category associated with the received column, wherein the defined primitive category entries for the root category are associated with a defined transformation function set.

7. A non-transitory program storage device comprising instructions stored thereon to cause one or more processors to:
receive a tabular training data set, the training data set including a set of one or more source columns;
identify column labels from the tabular training data set, the column labels associated with a received column of data points from the set of source columns;
determine, for an identified column label, a root category based on at least one of a user specification, data types, or distribution properties associated with the data points in the received column from the set of source columns;
perform one or more data transformations for data points in the received column, the one or more data transformations for extracting a grammatical structure shared between entries of a categoric feature set to obtain a transformed data set;
record column categories determined for each identified column label and properties of the data transformations performed for each source column in a metadata database;
output the metadata database and transformed training data set for training a ML system;
receive a tabular additional data set and the metadata database;
perform the one or more data transformations for data points in corresponding additional columns of the tabular additional data set using the recorded column categories and properties of the data transformations from the metadata database to obtain a transformed additional data set; and
output the transformed additional data set for use with the ML system.

8. The non-transitory program storage device of claim 7, wherein the instructions to perform data transformations for extracting the grammatical structure further cause the one or more processors to:
compare string character subsets of entries to string character subsets of other entries;
identify overlaps shared between string character subsets of entries; and
return one or more returned columns with activations corresponding to identified overlaps from received entries of the categoric feature set.

9. The non-transitory program storage device of claim 7, wherein the instructions to perform data transformations for extracting the grammatical structure further cause the one or more processors to:
compare string character subsets of entries to string character subsets of other entries;
identify overlaps shared between string character subsets of entries; and
return a returned column with entries from the categoric feature set consolidated into a fewer number of unique values according to the identified overlaps.

10. The non-transitory program storage device of claim 7, wherein the instructions to perform data transformations for extracting the grammatical structure further cause the one or more processors to:
inspect string character subset extracts of entries;
check validity of the extracts as numeric character sets; and
return a returned column with extracted numeric entries.

11. The non-transitory program storage device of claim 7, wherein the instructions to perform data transformations for extracting the grammatical structure further cause the one or more processors to:
receive one or more search terms as a parameter to a transformation function; and
return one or more returned columns with activations associated with identified search terms present as string character subsets in the entries of the categoric feature set.

12. The non-transitory program storage device of claim 7, wherein the instructions to perform data transformations for extracting the grammatical structure further cause the one or more processors to:
perform one or more data transformations for data points in a received column in an order based on defined primitives of a transformation tree to obtain a transformed data set, the transformation tree including defined primitive category entries associated with each root category, wherein the defined primitives associated with the received column are based on a root category associated with the received column, wherein the defined primitive category entries for the root category are associated with a defined transformation function set.

13. An electronic device, comprising:
a memory; and
one or more processors operatively coupled to the memory, wherein the one or more processors are configured to execute instructions causing the one or more processors to:
receive a tabular training data set, the training data set including a set of one or more source columns;
identify column labels from the tabular training data set, the column labels associated with a received column of data points from the set of source columns;
determine, for an identified column label, a root category based on at least one of a user specification, data types, or distribution properties associated with the data points in the received column from the set of source columns;
perform one or more data transformations for data points in the received column, the one or more data transformations for extracting a grammatical structure shared between entries of a categoric feature set to obtain a transformed data set;
record column categories determined for each identified column label and properties of the data transformations performed for each source column in a metadata database;
output the metadata database and transformed training data set for training a ML system;
receive a tabular additional data set and the metadata database;
perform the one or more data transformations for data points in corresponding additional columns of the tabular additional data set using the recorded column categories and properties of the data transformations from the metadata database to obtain a transformed additional data set; and
output the transformed additional data set for use with the ML system.

14. The device of claim 13, wherein the instructions to perform data transformations for extracting the grammatical structure further comprise instructions to cause the one or more processors to:
compare string character subsets of entries to string character subsets of other entries;
identify overlaps shared between string character subsets of entries; and
return one or more returned columns with activations corresponding to identified overlaps from received entries of the categoric feature set.

15. The device of claim 13, wherein the instructions to perform data transformations for extracting the grammatical structure further comprise instructions to cause the one or more processors to:
compare string character subsets of entries to string character subsets of other entries;
identify overlaps shared between string character subsets of entries; and
return a returned column with entries from the categoric feature set consolidated into a fewer number of unique values according to the identified overlaps.

16. The device of claim 13, wherein the instructions to perform data transformations for extracting a grammatical structure further comprise instructions to cause the one or more processors to:
inspect string character subset extracts of entries;
check validity of the extracts as numeric character sets; and
return a returned column with extracted numeric entries.

17. The device of claim 13, wherein the instructions to perform data transformations for extracting a grammatical structure further comprise instructions to cause the one or more processors to:
receive one or more search terms as a parameter to a transformation function; and
return one or more returned columns with activations associated with identified search terms present as string character subsets in the entries of the categoric feature set.

18. The device of claim 13, wherein the instructions to perform data transformations for extracting a grammatical structure further comprise instructions to cause the one or more processors to:
perform one or more data transformations for data points in a received column in an order based on defined primitives of a transformation tree to obtain a transformed data set, the transformation tree including defined primitive category entries associated with each root category, wherein the defined primitives associated with the received column are based on a root category associated with the received column, wherein the defined primitive category entries for the root category are associated with a defined transformation function set.

19. A system comprising:
a memory; and
one or more processors operatively coupled to the memory, wherein the one or more processors are configured to execute instructions causing the one or more processors to:
receive a tabular training data set, the training data set including a set of one or more source columns;
identify column labels from the tabular training data set, the column labels associated with a received column of data points from the set of source columns;
determine, for an identified column label, a root category based on at least one of a user specification, data types, or distribution properties associated with the data points in the received column from the set of source columns;
perform one or more data transformations for data points in the received column, the one or more data transformations for extracting a grammatical structure shared between entries of a categoric feature set to obtain a transformed data set;
record column categories determined for each identified column label and properties of the data transformations performed for each source column in a metadata database;
output the metadata database and transformed training data set for training a ML system;
receive a tabular additional data set and the metadata database;
perform the one or more data transformations for data points in corresponding additional columns of the tabular additional data set using the recorded column categories and properties of the data transformations from the metadata database to obtain a transformed additional data set; and
output the transformed additional data set for use with the ML system.

20. The system of claim 19, wherein the one or more processors are configured to execute instructions to perform data transformations for extracting the grammatical structure further cause the one or more processors to:
compare string character subsets of entries to string character subsets of other entries;
identify overlaps shared between string character subsets of entries; and
return one or more returned columns with activations corresponding to identified overlaps from received entries of the categoric feature set.

21. The system of claim 19, wherein the one or more processors are configured to executed instructions to perform data transformations for extracting a grammatical structure further cause the one or more processors to:
compare string character subsets of entries to string character subsets of other entries;
identify overlaps shared between string character subsets of entries; and
return a returned column with entries from the categoric feature set consolidated into a fewer number of unique values according to the identified overlaps.

22. The system of claim 19, wherein the one or more processors are configured to executed instructions to perform data transformations for extracting a grammatical structure further cause the one or more processors to:
inspect string character subset extracts of entries;
check validity of the extracts as numeric character sets; and
return a returned column with extracted numeric entries.

23. The system of claim 19, wherein the one or more processors are configured to executed instructions to perform data transformations for extracting a grammatical structure further cause the one or more processors to:
receive one or more search terms as a parameter to a transformation function; and
return one or more returned columns with activations associated with identified search terms present as string character subsets in the entries of the categoric feature set.

24. The system of claim 19, wherein the one or more processors are configured to executed instructions to perform data transformations for extracting a grammatical structure further cause the one or more processors to:
perform one or more data transformations for data points in a received column in an order based on defined primitives of a transformation tree to obtain a transformed data set, the transformation tree including defined primitive category entries associated with each root category, wherein the defined primitives associated with the received column are based on a root category associated with the received column, wherein the defined primitive category entries for the root category are associated with a defined transformation function set.
